(19) United States
(12) Patent Application Publication
(10) Pub. No.: US 2026/0128613 A1
(43) Pub. Date: May 7, 2026

(54) ENERGY SOURCE IDENTIFICATION EMBEDDING

(71) Applicant: INTERNATIONAL BUSINESS MACHINES CORPORATION, ARMONK, NY (US)

(72) Inventors: Erik Rueger, Ockenheim (DE); Paritosh Ranjan, Kolkata (IN)

(21) Appl. No.: 18/934,679

(22) Filed: Nov. 1, 2024

(51) Int. Cl. H02J 13/00; G06Q 50/06

(52) U.S. Cl. CPC H02J 13/1315; G06Q 50/06; H02J 13/10

(57) ABSTRACT

According to one embodiment, a method, computer system, and computer program product for embedding energy source identification signals is provided. The present invention may include inducing an energy source identification signal into each of one or more electricity streams using one or more modulation techniques; receiving one or more redistributed electricity streams at an electricity consumption site from an electricity station; extracting one or more energy source identification signals from each of the one or more redistributed electricity streams using one or more demodulation techniques; and displaying visual information on a graphical user interface, wherein the visual information depicts de-embedded information in the extracted one or more energy source identification signals.

### BACKGROUND

The present invention relates, generally, to the field of computing, and more particularly, to signal modulation.

Signal modulation is the process of imposing a modulation signal onto a carrier wave by changing the carrier wave's properties. Signal modulation is used to transmit information contained within an input modulation signal by changing the amplitude, frequency, or phase of the carrier wave, to encode the information into the carrier wave. Subsequently, the modulated carrier wave can transmit the encoded information as an analog or digital signal.

### SUMMARY

Embodiments of a method, a computer system, and a computer program product for embedding energy source identification signals into electricity streams are described. According to at least one embodiment, a method, computer system, and computer program product for embedding energy source identification signals into electricity streams may include inducing an energy source identification signal into each of one or more electricity streams using one or more modulation techniques; receiving one or more redistributed electricity streams at an electricity consumption site from an electricity station; extracting one or more energy source identification signals from each of the one or more redistributed electricity streams using one or more demodulation techniques; and displaying visual information on a graphical user interface, where the visual information depicts de-embedded information in the extracted one or more energy source identification signals.

### BRIEF DESCRIPTION OF THE SEVERAL VIEWS OF THE DRAWINGS

These and other objects, features, and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment.

FIG. 2 is an operational flowchart illustrating an energy source identification embedding process according to at least one embodiment.

FIG. 3 is an operational flowchart illustrating a mixed energy source identification embedding process according to at least one embodiment.

FIG. 4 is an illustration of an energy source identification embedding system according to at least one embodiment.

FIG. 5 depicts a visual representation of a graphical user interface of the system according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate generally to the field of computing, and in particular, to embedding energy source identification signals into electricity streams. The present embodiment can use signal modulation techniques to induce an energy source identification signal into an outgoing electricity stream based on the type of energy used to generate the electricity in the outgoing electricity stream. Additionally, the present embodiment can use signal demodulation techniques to extract and decode the energy source identification signals from an incoming electricity stream and display information that depicts the source(s) of energy used to generate the electricity in the incoming electricity stream.

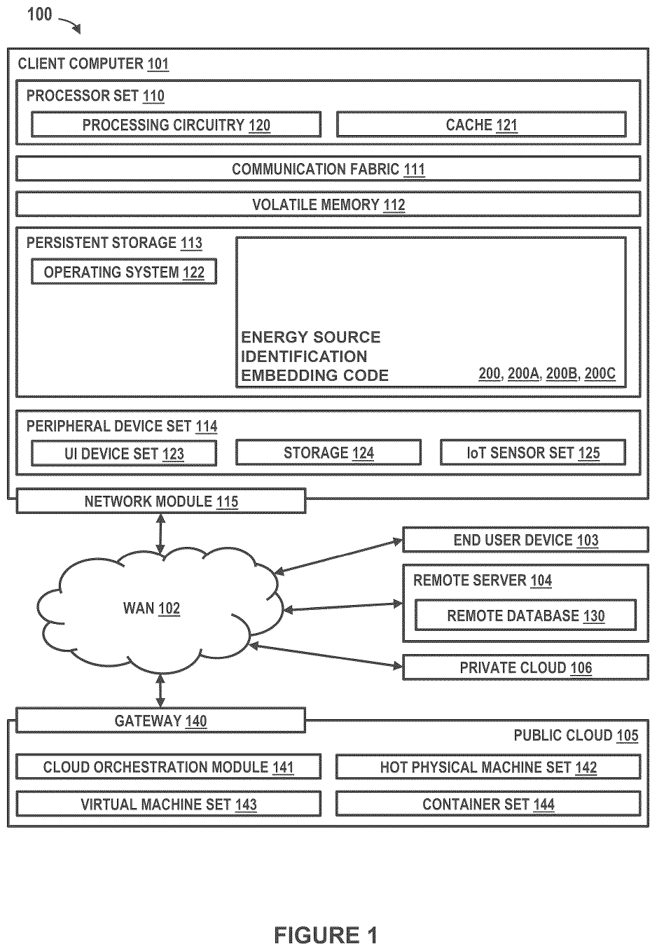

The embodiments mentioned in this paragraph are further illustrated and described below in the discussions of FIGS. 1, 2, 3, 4, and 5. According to at least one embodiment of the invention, the energy source identification embedding program induces an energy source identification signal into each of one or more electricity streams using one or more modulation techniques. Also, the program receives one or more redistributed electricity streams at an electricity consumption site from an electricity station. Furthermore, the program extracts one or more energy source identification signals from each of the one or more redistributed electricity streams using one or more demodulation techniques. Moreover, the program displays visual information on a graphical user interface, wherein the visual information depicts de-embedded information in the extracted one or more energy source identification signals.

Thus, embodiments of the present invention may provide advantages including, but not limited to, enabling end consumers to make environmentally friendly informed decisions regarding where their electricity is sourced. The present invention uses modulation and demodulation techniques to induce/extract information into an electricity stream, thereby enabling information about energy sources to be transmitted in electricity streams. The present invention displays visual information that depicts the sources of energy used to generate the electricity at an electric consumption site, thereby enabling end consumers to be aware of and assured of where their electricity is sourced. The present invention does not require that all advantages need to be incorporated into every embodiment of the invention.

According to at least one other embodiment, the program receives each of the one or more electricity streams at the electricity station. According to at least one other embodiment, the program extracts the energy source identification signal from each of the one or more electricity streams using the one or more demodulation techniques. According to at least one other embodiment, the program reinduces one or more of the extracted energy source identification signals into each of the one or more redistributed electricity streams using the one or more modulation techniques. In this embodiment, the present invention has the advantage of comprising redistributed electricity streams with electricity sourced from mixed energy sources.

According to at least one other embodiment, each of the energy source identification signals comprises an encoding of a type and an amount of an energy source used to generate electricity in the electricity stream the energy source identification signal was inducted or reinduced into. In this embodiment, the present invention has the advantage of transmitting information about the sources of energy used to generate electricity in an electricity stream, as well as a breakdown of the portions of electricity generated in the electricity stream from each source.

According to at least one other embodiment, a type of energy source used to generate electricity can comprise either a renewable energy source, a nuclear energy source, or a fossil energy source. In this embodiment, the present invention has the advantage of identifying each existing energy source that is used to generate electricity and thus, is not limited to identifying only a limited amount of energy sources.

According to at least one other embodiment, the extracting of the one or more energy source identification signals from each of the one or more redistributed electricity streams and the extracting of the energy source identification signal from each of the one or more electricity streams using the one or more demodulation techniques comprises de-embedding encodings of one or more energy sources in each of the one or more redistributed electricity streams and the one or more electricity stream. In this embodiment, the present invention has the advantage of de-embedding encodings transmitted in electricity streams, thus enabling the identification of the energy sources used to generate the electricity to be extracted from electricity streams.

According to at least one other embodiment, the inducing of the energy source identification signal into each of one or more electricity streams and the reinducing of the one or more of the extracted energy source identification signals into each of the one or more redistributed electricity streams using the one or more modulation techniques comprises embedding encodings of one or more energy sources in each of the one or more redistributed electricity streams and the one or more electricity stream. In this embodiment, the present invention has the advantage of embedding encodings into electricity streams, thus enabling the identification of the energy sources used to generate the electricity to be transmitted in the electricity streams.

According to at least one other embodiment, an electricity stream can comprise electricity generated from one energy source, and a redistributed electricity stream can comprise either electricity generated from one energy source, or a mixture of electricity generated from multiple energy sources. In this embodiment, the present invention has the advantage of transmitting the identification of a single energy source used to generate the electricity in an electricity stream and the identification of multiple energy sources used to generate the electricity in a mixed electricity stream.

Currently, methods that induce and extract energy source identification signals into/from electricity streams, and display visual information depicting the information comprised within the signals do not exist. However, as more electricity end consumers strive to make environmentally conscious decisions, it is important that a method exists that allows the end consumers to be aware of where their electricity is sourced, and, as a result, enables them to request where their electricity is sourced from. Therefore, an implementation of an energy source identification embedding process is needed, in which signal modulation techniques are used to induce energy source identification signals into electricity streams, signal demodulation techniques are used to extract the energy source identification signals from incoming electricity streams, and the information comprised within the extracted energy source identification signals is displayed.

In at least one exemplary embodiment, the program induces an energy source identification amplitude signal into an electricity stream, representing that the electricity in the electricity stream was generated using a solar energy source. The electricity stream is distributed from the electricity generation source to an electricity station. The electricity station redistributes the electricity stream to an electricity consumption site. At the electricity consumption site, the program extracts the energy source identification amplitude signal from the redistributed electricity stream and determines that the electricity was generated from a solar energy source based on the predefined constraints of the extracted amplitude signal. The program displays visual information depicting that the electricity was 100% sourced from solar energy.

In at least one exemplary embodiment, at a first electricity generation source, the program induces an energy source identification frequency signal into an electricity stream, representing that the electricity in the electricity stream was generated using a wind energy source. Additionally, at a second electricity generation source, the program induces an energy source identification frequency signal into an electricity stream, representing that the electricity in the electricity stream was generated using a nuclear energy source. The electricity streams are distributed from the respective electricity generation sources to an electricity station. The electricity station extracts the energy source identification signals from the electricity streams. The electricity station redistributes the electricity streams into a mixed electricity stream. Subsequently, at the electricity station, the program induces two energy source identification phase signals into the mixed electricity stream. The first energy source identification phase signal comprises information representing that 65% of the electricity in the mixed electricity stream was sourced from wind energy. The second energy source identification phase signal comprises information representing that 35% of the electricity in the mixed electricity stream was sourced from nuclear energy. The electricity station then redistributes the mixed electricity stream to an electricity consumption site. At the electricity consumption site, the program extracts the energy source identification phase signals from the redistributed electricity stream and determines that the electricity was generated from both wind and nuclear energy sources based on the predefined constraints of the extracted phase signals. The program displays visual information depicting that the electricity was 65% sourced from wind energy and 35% sourced from nuclear energy.

The present invention may be a system, a method, and/or a computer program product at any possible technical detail level of integration. The computer program product may include a computer-readable storage medium (or media) having computer-readable program instructions thereon for causing a processor to carry out aspects of the present invention.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

The following described exemplary embodiments provide a system, method, and program product to induce an energy source identification signal into each of one or more electricity streams using one or more modulation techniques, receive one or more redistributed electricity streams at an electricity consumption site from an electricity station, extract one or more energy source identification signals from each of the one or more redistributed electricity streams using one or more demodulation techniques, and display visual information on a graphical user interface, where the visual information depicts de-embedded information in the extracted one or more energy source identification signals.

Referring to FIG. 1, an exemplary networked computer environment 100 is depicted, according to at least one embodiment. Computing environment 100 contains an example of an environment for the execution of at least some of the computer code involved in performing the inventive methods, such as energy source identification embedding code 200, also referred to as “energy source identification embedding program 200” , or “the program 200”. Program 200 may be separate functions/features in the same program 200, or separate modules, 200A, 200B, and 200C. Module 200A may be an implementation of program 200 that can perform signal modulation. Module 200B may be an implementation of program 200 that can perform signal modulation and signal demodulation. Module 200C may be an implementation of program 200 that can perform signal demodulation, as well as display information representing demodulated and decoded signals. Modules 200A, 200B, and 200C, can be additional instances of program 200 as shown in FIG. 1. In addition to code block 200, 200A, 200B, and 200C, computing environment 100 includes, for example, computer 101, wide area network (WAN) 102, end-user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and code block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer, or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

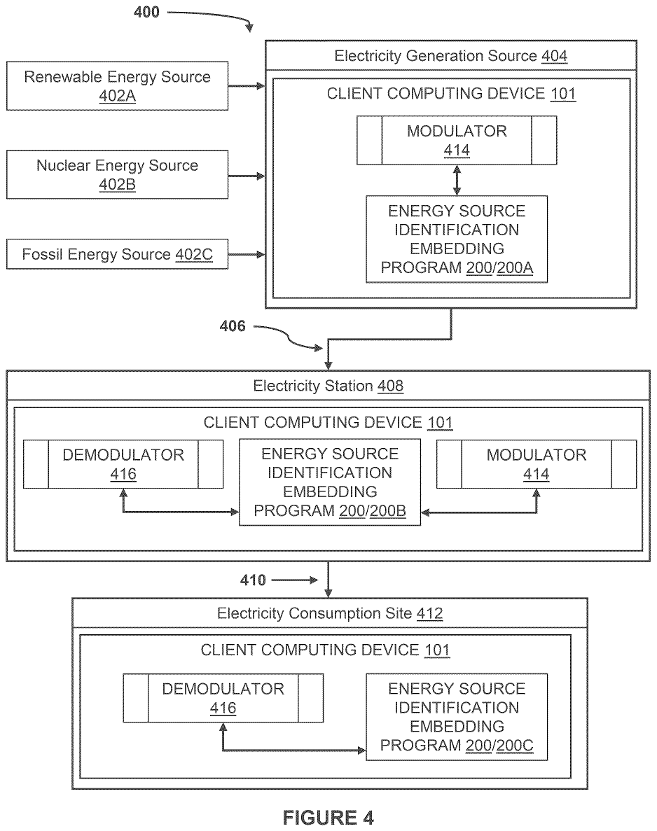

Additionally, computer 101 may comprise a modulator module 414 (FIG. 4), a demodulator module 416 (FIG. 4), or both. A modulator module 414 can be an electronic circuit used to embed and induce information represented by amplitude, frequency, and phase signals modulated onto outgoing carrier waves. A demodulator module 416 can be a circuit, i.e. a receiver, used to separate and decode information represented by amplitude, frequency, and phase signals modulated onto received carrier waves.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off-chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby affect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in code block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports, and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read-only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in code block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Also, UI device set 123 may include intelligent lighting systems, such as light-emitting diodes (LEDs). Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer, and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs, and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The database 130 may be a digital repository capable of data storage and data retrieval. The database 130 can be present in the remote server 104 and/or any other location in the network 102. The database 130 may comprise a knowledge corpus, whereby the knowledge corpus is maintained by the program 200. The knowledge corpus may store energy source identification signal information. Energy source identification signal information may comprise the predefined constraints, established via a global standard, of the plurality of energy source identification amplitude, frequency, and phase signals. An energy source identification signal can comprise encodings representing the predefined constraints of its corresponding amplitude, frequency, or phase signal. The predefined constraints of an amplitude, frequency, or phase signal can correspond to the energy source 402A (FIG. 4), 402B (FIG. 4), 402C (FIG. 4) used to generate the electricity in an electricity stream 406 (FIG. 4), as well as the portion of the electricity generated from the energy source 402A, 402B, 402C that is comprised within in the electricity stream 406. Additionally, the predefined constraints may be associated with a color and a brightness, used to light up light-emitting diodes (LEDs) in a set of LEDs 123. The database 130 can be accessible by electricity producers and electricity equipment manufacturers.

Each energy source 402A, 402B, 402C may have unique predefined constraints for an amplitude, frequency, and phase signal, as well as predefined constraints for each signal based on the portion of the electricity generated from the energy source 402A, 402B, 402C that is comprised within in the electricity stream 406 For example, predefined constraints of a phase signal that represent that a solar energy source was used to generate all the electricity in an electricity stream 406 may be between SolarPhaseHigh (representing a higher-end phase value) and SolarPhaseLow (representing a lower-end phase value). Additionally, for example, predefined constraints of an amplitude signal that represent that a solar energy source was used to generate all the electricity in an electricity stream 406 may be between SolarAmplitudeHigh (representing a higher-end amplitude value) and SolarAmplitudeLow (representing a lower-end amplitude value). Furthermore, for example, predefined constraints of a frequency signal that represent that a solar energy source was used to generate all the electricity in an electricity stream 406 may be between SolarFrequencyHigh (representing a higher-end frequency value) and SolarFrequencyLow (representing a lower-end frequency value). Moreover, each energy source may have respective corresponding predefined constraints between non-overlapping lower-end phase/amplitude/frequency values and higher-end phase/amplitude/frequency values that represent that a portion of electricity in an electricity stream, for example, 30%, was generated using the energy source.

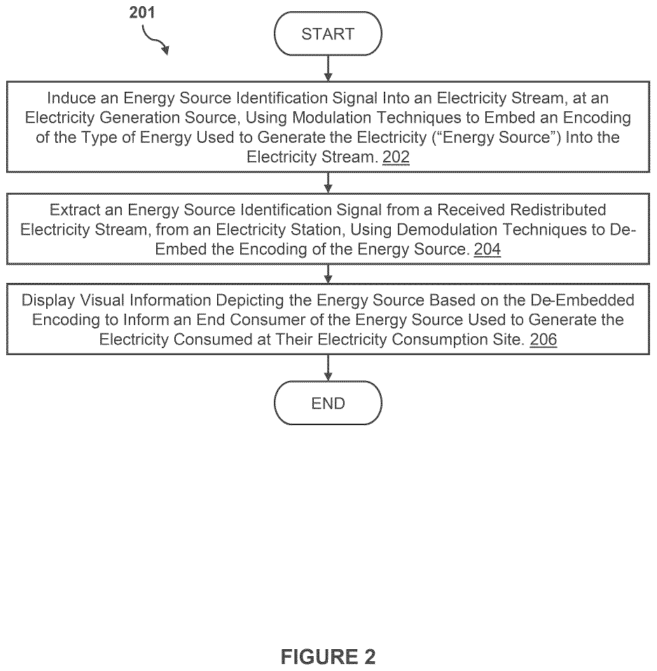

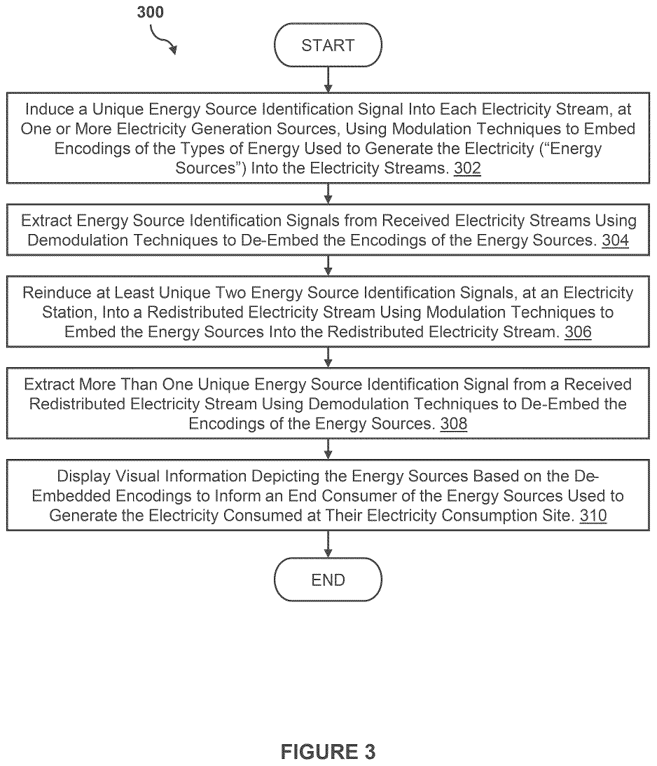

According to the present embodiment, the energy source identification embedding program 200, or module 200A, module 200B, and module 200C, may be a program capable of performing an energy source identification embedding process 201 and a mixed energy source identification embedding process 300. More specifically, the program 200 may be a program capable of inducing an energy source identification signal into each of one or more electricity streams using one or more modulation techniques. Also, the program 200 may be a program capable of receiving one or more redistributed electricity streams at an electricity consumption site from an electricity station. Additionally, the program 200 may be a program capable of extracting one or more energy source identification signals from each of the one or more redistributed electricity streams using one or more demodulation techniques. Moreover, the program 200 may be a program capable of displaying visual information on a graphical user interface, wherein the visual information depicts de-embedded information in the extracted one or more energy source identification signals. Furthermore, the program 200 may be a program capable of reinducing one or more extracted energy source identification signals into each of the one or more redistributed electricity streams using the one or more modulation techniques. The program 200, or module 200A, module 200B, and module 200C, may be located on client computing device 101 or remote server 104 or on any other device located within network 102. Furthermore, the program 200, or module 200A, module 200B, and module 200C, may be distributed in its operation over multiple devices, such as client computing device 101 and remote server 104. The energy source identification embedding method is explained in further detail below with respect to FIG. 2. Additionally, a mixed energy source identification embedding method is explained in further detail below with respect to FIG. 3.

Referring now to FIG. 2, an operational flowchart illustrating an energy source identification embedding process 201 is depicted according to at least one embodiment. At 202, the program 200/module 200A induces an energy source identification signal into an electricity stream 406 using modulation techniques to embed an encoding of the type of energy used to generate the electricity into the electricity stream 406. A “type of energy used to generate the electricity in the electricity stream” may herein be referred to as an “energy source”. The program 200/module 200A can induce an energy source identification signal into an electricity stream 406 by performing either amplitude modulation, frequency modulation, or phase modulation, using modulator module 414. The modulator module 414 can induce either an amplitude signal, a frequency signal, or a phase signal into the respective electricity stream 406, pursuant to the predefined amplitude/frequency/phase signal constraints of the corresponding energy source 402A, 402B, 402C used to generate the electricity into the electricity stream 406, to embed the encodings of the energy source 402A, 402B, 402C into the electricity stream 406. More specifically, by inducing an amplitude, frequency, or phase signal into the electricity stream 406 pursuant to the predefined amplitude/frequency/phase signal constraints listed within the database 130, the program 200/module 200A changes the respective lower-end phase/amplitude/frequency values and higher-end phase/amplitude/frequency values of the carrier wave in the electricity stream 406 to represent the identity of the energy source 402A, 402B, 402C.

The energy sources can comprise renewable energy 402A, such as wind, solar, geothermal, and hydropower, nuclear energy 402B, and fossil energy 402C, such as oil, coal, and natural gas. As previously stated, an energy source identification signal can comprise an encoding of the predefined constraints of an induced amplitude, frequency, or phase signal that corresponds to an energy source 402A, 402B, 402C used to generate the electricity in an electricity stream 406, as well as the portion of the electricity in the electricity stream 406 that was generated from the energy source 402A, 402B, 402C. An electricity stream 406 can be an electric current or potential.

The program 200/module 200A induces the energy source identification signal into the electricity stream 406 at an electricity generation source 404 (FIG. 4). An electricity generation source 404 can be one or more distinct plants/facilities that are built around the specific fuel used to create electricity, for example, a hydro-electric plant, nuclear facility, fossil fuel facility, solar field, wind field, etc., where the sources of energy are collected and converted to electricity. The electricity generation source 404 distributes the electricity stream 406 to an electricity station 408 (FIG. 4). An electricity substation 408 can comprise an electricity substation/transformer station. An electricity substation/transformer station 408 may comprise transformers that change voltage levels between high transmission voltages and lower distribution voltages, or at the interconnection of two different transmission voltages. An electricity station 408 may be part of an electrical, transmission, and distribution system, at which electric power flows between an electricity generation source 404 and an electricity consumption site 412 (FIG. 4). Between an electricity generation source 404 and an electricity consumption site 412, electric power, i.e. electricity stream 406, may flow between one or more electricity stations 408. The electricity station 408 redistributes the electricity stream 406 to one or more electricity consumption sites 412 through a redistributed electricity stream 410. An electricity consumption site can be a location where electricity is consumed by an end consumer, such as a house, a building, etc. A redistributed electricity stream 410 can be an electricity stream comprising electricity generated from one energy source 402A, 402B, 402C through an electricity stream 406, or an electricity stream comprising electricity generated from more than one electricity source through multiple electricity streams 406, such as a wind energy source 402A and a solar energy source 402, an oil energy source 402C and a coal energy source 402C, a geothermal energy source 402A and a nuclear energy source 402B, a hydropower source 402A and a wind energy source 402C, a natural gas energy source 402A, a nuclear energy source 402B, and a natural gas energy source 402C, etc.

At 204, the program 200/module 200C extracts an energy source identification signal from a redistributed electricity stream 410 using demodulation techniques to de-embed the encoding of the energy source 402A, 402B, 402C used to generate the electricity in the received redistributed electricity stream 410. Upon receiving a redistributed electricity stream 410 at an electricity consumption site from an electricity generation source 404, the program 200/module 200C can extract the energy source identification signal from the redistributed electricity stream 410 by performing either amplitude demodulation, frequency demodulation, or phase demodulation, using demodulator module 416. The demodulator module 416 can extract either an amplitude signal, a frequency signal, or a phase signal from the redistributed electricity stream 410, to de-embed the encodings of the energy source 402A, 402B, or 402C from the redistributed electricity stream 410. More specifically, by extracting an amplitude/frequency/phase signal from the redistributed electricity stream 410, the program 200/module 200C can identify the energy source 402A, 402B, or 402C pursuant to the predefined amplitude/frequency/phase signal constraints listed within the database 130, i.e. by matching the extracted signal's lower-end phase/amplitude/frequency value and higher-end phase/amplitude/frequency value to the predefined amplitude/frequency/phase signal constraints listed within the database 130.

At 206, the program 200/module 200C displays visual information depicting the identified energy source 402A, 402B, or 402C. The program 200/module 200C can display the visual information depicting the identified energy source 402A, 402B, or 402C to inform an electricity end consumer of the energy source 402A, 402B, 402C used to generate the electricity consumed at their electricity consumption site 412. The visual information can comprise an energy source breakdown. An energy source breakdown may comprise images, such as graphs or pie charts, or text depicting the identified energy source 402A, 402B, or 402C. The program 200/module 200C can display the energy source breakdown on one or more client computing devices 101 through a graphical user interface (“GUI”). For example, the program 200/module 200C may display a pie chart showing that the electricity in the redistributed electricity stream 410 was 100% sourced from a solar energy source 402A.

Referring now to FIG. 3, an operational flowchart illustrating a mixed energy source identification embedding process 300 is depicted according to at least one embodiment. At 302, the program 200/module 200A induces a unique energy source identification signal into each electricity stream 406, at multiple electricity generation sources 404, using the modulation techniques to respectively embed encodings of the types of energy used to generate the electricity into the electricity streams 406. The “types of energy used to generate the electricity in the electricity stream” may herein be referred to as the “energy sources”. The program 200/module 200A can perform the inducing in the same manner as the inducing performed in step 202, except that the present step comprises inducing a unique energy source identification signal at more than one electricity generation source 404.

At 304, the program 200/module 200B extracts energy source identification signals from electricity streams 406 using demodulation techniques to de-embed the encodings of the energy sources 402A, 402B, or 402C used to generate the electricity in the received electricity streams 406. The program 200/module 200B may perform the extracting of the energy source identification signals from each received electricity stream 406 in the same manner as the extracting performed in step 204, except that the present step comprises extracting energy source identification signals from multiple electricity streams 406, and the extracting is performed at an electricity station 408, and not an electricity consumption site 412.

At 306, the program 200/module 200B reinduces at least two unique energy source identification signals into a redistributed electricity stream 410 using modulation techniques to embed encodings of the energy sources 402A, and/or 402B, and/or 402C into the redistributed electricity stream 410. The program 200/module 200B can perform the reinducing of the at least two unique energy source identification signals into a redistributed electricity stream 410 in the same manner as the inducing performed in steps 202 and 302, except that the present step comprises inducing two or more unique energy source identification signals and is performed at an electricity station 408, and not an electricity generation source 404. The program 200/module 200B can induce two or more unique energy source identification signals into a redistributed electricity stream 410 pursuant to the mixture of electricity streams 406 the electricity station 408 combines to form the redistributed electricity stream 410. For example, the electricity station 408 may receive an electricity stream 406 from three separate electricity generation sources 404. The electricity streams 406 may comprise electricity generated from a wind energy source 402A, a nuclear energy source 402B, and an oil energy source 402C, respectively, determined via the extraction of the energy source identification signals performed in step 304. The electricity station 408 can combine a portion of each of the three electricity streams 406 into a redistributed electricity stream 410, creating a mixture of electricity generated from energy sources 402A, 402B, 402C. Subsequently, the program 200/module 200B can induce three unique energy source identification signals into the redistributed electricity stream 410, pursuant to the portion of electricity in the redistributed electricity stream 410 from each of the three energy sources 402A, 402B, and 402C, such as an energy source identification signal representing that 55% of the electricity in the redistributed electricity stream 410 is from the wind energy source 402A, a second energy source identification signal representing that 25% of the electricity in the redistributed electricity stream 410 is from the nuclear energy source 402B, and a third energy source identification signal representing that 20% of the electricity in the redistributed electricity stream 410 is from the fossil energy source 402C. The electricity station 408 can distribute the redistributed electricity stream 410 to one or more electricity consumption sites 412.

At 308, the program 200/module 200C extracts more than one unique energy source identification signal from a redistributed electricity stream 410 using demodulation techniques to de-embed the encodings of the energy sources 402A, and/or 402B, and/or 402C used to generate the electricity in the received redistributed electricity stream 410. The program 200/module 200C can perform the extracting of the energy source identification signals from a redistributed electricity stream 410 in the same manner as the extracting performed in step 206, except that the present step comprises extracting more than one energy source identification signal from a redistributed electricity stream 410.

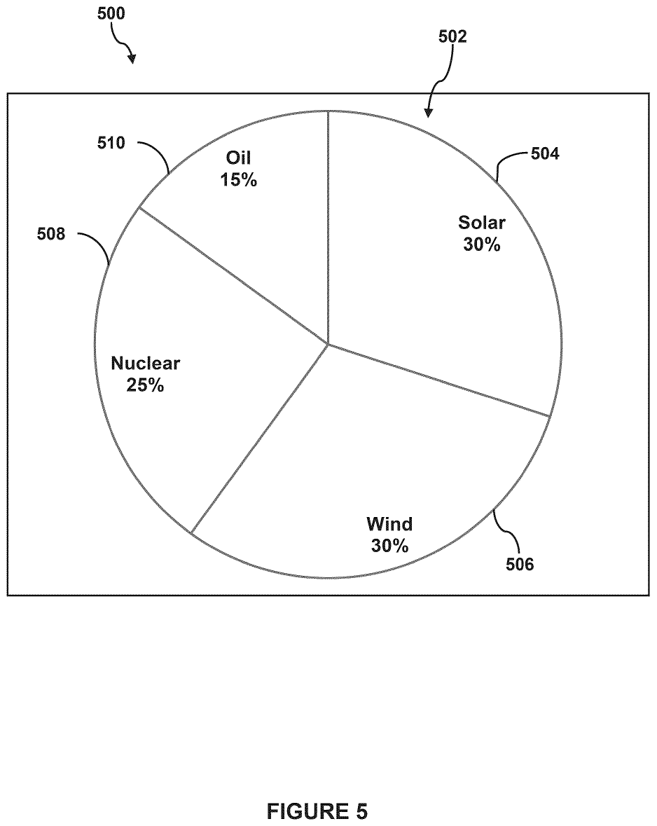

At 310, the program 200/module 200C displays visual information depicting the identified energy sources 402A, 402B, 402C. The program 200/module 200C can perform the displaying of the visual information on one or more client computing devices 101 through a graphical user interface (“GUI”) in the same manner as in step 206, except that the present step comprises displaying an energy source breakdown of the two or more energy sources 402A, 402B, 402C used to generate the electricity consumed at the electricity end consumer's electricity consumption site 412. For example, the program 200/module 200C may display a pie chart 502 (FIG. 5) showing that the electricity in the redistributed electricity stream 410 was 30% sourced from a solar energy source 402A, 504 (FIGS. 5), 30% sourced from a wind energy source 402A, 506 (FIGS. 5), 25% sourced from a nuclear energy source 402B, 508 (FIG. 5), and 15% sourced from an oil energy source 402C, 510 (FIG. 5), as depicted in a visual representation of a graphical user interface of the system 500 (FIG. 5) according to at least one embodiment. The pie chart 502 can be displayed as shown in FIG. 5, or using color, cross-hatching, shading, or similar.

Also, in at least one embodiment, the program 200/module 200C may perform the displaying of the visual information by representing the identified energy sources 402A, 402B, 402C using one or more sets of light-emitting diodes (LEDs) 123, whereby each set of LEDs 123 is connected to a device that consumes electricity within the electricity consumption site 412, for example, a television set, a refrigerator, a washer, a light, etc. A set of LEDs 123 can include a plurality of LEDs 123. The program 200/module 200C may connect to the one or more sets of LEDs 123 in the electricity consumption site 412 through Bluetooth. The program 200/module 200C can light each set of LEDs 123 connected to the devices in the same manner. The program 200/module 200C can light up each LED 123 in a set of LEDs 123 a specific color pursuant to the energy sources 402A, 402B, 402C used to generate the electricity consumed by the one or more devices, i.e. the electricity consumed at the electricity consumption site 412, as well as a specific brightness pursuant to the portion of the electricity in the redistributed electricity stream 410 from each of the energy sources 402A, 402B, and 402C. For example, the program 200/module 200C may light up an LED 123 in a set of LEDs 123 orange with low brightness, indicating that 30% of the electricity consumed by the device was sourced from a solar energy source 402A, another LED 123 in the set of LEDs 123 blue with medium brightness, indicating that 30% of the electricity consumed by the device was sourced from a wind energy source 402A, another LED 123 in the set of LEDs 123 yellow with medium brightness, indicating that 25% of the electricity consumed by the device was sourced from a nuclear energy source 402B, and another LED 123 in the set of LEDs 123 red with full brightness, indicating 15% of the electricity consumed by the device was sourced from an oil energy source 402C.

Referring now to FIG. 4, an illustration of an energy source identification embedding system 400 is depicted according to at least one embodiment. A system diagram illustrating an exemplary environment 400 of an implementation of an energy source identification embedding process 201/mixed energy source identification embedding process 300 is depicted according to at least one embodiment. The exemplary environment 400 comprises a renewable energy source 402A, a nuclear energy source 402B, a fossil energy source 402C, an electricity generation source 404, an electricity station 408, and an electricity consumption site 412. Here, the electricity generation source 404 comprises a modulator module 414 and the program 200/module 200A. The electricity station 408 comprises a modulator module 414, a demodulator module 416, and the program 200/module 200B. The electricity consumption site 412 comprises a demodulator module 416 and the program 200/module 200C. The exemplary environment 400 details the passages of electricity 406 between the electricity generation source 404 and the electricity station 408, and the electricity station 408 and the electricity consumption site 412. Additionally, the exemplary environment 400 details the interactions between the modulator module 414 and the program 200/module 200A, the modulator module 414 and the program 200/module 200B, the demodulator module 416 and the program 200/module 200B, and the demodulator module 416 and the program 200/module 200C.

It may be appreciated that FIGS. 2 through 5 provide only an illustration of one implementation and do not imply any limitations with regard to how different embodiments may be implemented. Many modifications to the depicted environments may be made based on design and implementation requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for embedding energy source identification signals, the method comprising:
inducing an energy source identification signal into each of one or more electricity streams using one or more modulation techniques;
receiving one or more redistributed electricity streams at an electricity consumption site from an electricity station;
extracting one or more energy source identification signals from each of the one or more redistributed electricity streams using one or more demodulation techniques; and
displaying visual information on a graphical user interface, wherein the visual information depicts de-embedded information in the extracted one or more energy source identification signals.

2. The method of claim 1, the method further comprising:
receiving each of the one or more electricity streams at the electricity station;
extracting the energy source identification signal from each of the one or more electricity streams using the one or more demodulation techniques; and
reinducing one or more of the extracted energy source identification signals into each of the one or more redistributed electricity streams using the one or more modulation techniques.

3. The method of claim 2, wherein each of the energy source identification signals comprise an encoding of a type and an amount of an energy source used to generate electricity in the electricity stream the energy source identification signal was inducted or reinduced into.

4. The method of claim 3, wherein a type of energy source used to generate electricity can comprise either a renewable energy source, a nuclear energy source, or a fossil energy source.

5. The method of claim 2, wherein the extracting of the one or more energy source identification signals from each of the one or more redistributed electricity streams and the extracting of the energy source identification signal from each of the one or more electricity streams using the one or more demodulation techniques comprises de-embedding encodings of one or more energy sources in each of the one or more redistributed electricity streams and the one or more electricity stream.

6. The method of claim 2, wherein an electricity stream can comprise electricity generated from one energy source, and a redistributed electricity stream can comprise either electricity generated from one energy source, or a mixture of electricity generated from multiple energy sources.

7. The method of claim 2, wherein the inducing of the energy source identification signal into each of one or more electricity streams and the reinducing of the one or more of the extracted energy source identification signals into each of the one or more redistributed electricity streams using the one or more modulation techniques comprises embedding encodings of one or more energy sources in each of the one or more redistributed electricity streams and the one or more electricity stream.

8. A computer system for embedding energy source identification signals, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
inducing an energy source identification signal into each of one or more electricity streams using one or more modulation techniques;
receiving one or more redistributed electricity streams at an electricity consumption site from an electricity station;
extracting one or more energy source identification signals from each of the one or more redistributed electricity streams using one or more demodulation techniques; and
displaying visual information on a graphical user interface, wherein the visual information depicts de-embedded information in the extracted one or more energy source identification signals.

9. The computer system of claim 8, the method further comprising:
receiving each of the one or more electricity streams at the electricity station;
extracting the energy source identification signal from each of the one or more electricity streams using the one or more demodulation techniques; and
reinducing one or more of the extracted energy source identification signals into each of the one or more redistributed electricity streams using the one or more modulation techniques.

10. The computer system of claim 9, wherein each of the energy source identification signals comprise an encoding of a type and an amount of an energy source used to generate electricity in the electricity stream the energy source identification signal was inducted or reinduced into.

11. The computer system of claim 10, wherein a type of energy source used to generate electricity can comprise either a renewable energy source, a nuclear energy source, or a fossil energy source.

12. The computer system of claim 9, wherein the extracting of the one or more energy source identification signals from each of the one or more redistributed electricity streams and the extracting of the energy source identification signal from each of the one or more electricity streams using the one or more demodulation techniques comprises de-embedding encodings of one or more energy sources in each of the one or more redistributed electricity streams and the one or more electricity stream.

13. The computer system of claim 9, wherein an electricity stream can comprise electricity generated from one energy source, and a redistributed electricity stream can comprise either electricity generated from one energy source, or a mixture of electricity generated from multiple energy sources.

14. The computer system of claim 9, wherein the inducing of the energy source identification signal into each of one or more electricity streams and the reinducing of the one or more of the extracted energy source identification signals into each of the one or more redistributed electricity streams using the one or more modulation techniques comprises embedding encodings of one or more energy sources in each of the one or more redistributed electricity streams and the one or more electricity stream.

15. A computer program product for embedding energy source identification signals, the computer program product comprising:
one or more computer-readable tangible storage medium and program instructions stored on at least one of the one or more tangible storage medium, the program instructions executable by a processor to cause the processor to perform a method comprising:
inducing an energy source identification signal into each of one or more electricity streams using one or more modulation techniques;
receiving one or more redistributed electricity streams at an electricity consumption site from an electricity station;
extracting one or more energy source identification signals from each of the one or more redistributed electricity streams using one or more demodulation techniques; and
displaying visual information on a graphical user interface, wherein the visual information depicts de-embedded information in the extracted one or more energy source identification signals.

16. The computer program product of claim 15, the method further comprising:
receiving each of the one or more electricity streams at the electricity station;
extracting the energy source identification signal from each of the one or more electricity streams using the one or more demodulation techniques; and
reinducing one or more of the extracted energy source identification signals into each of the one or more redistributed electricity streams using the one or more modulation techniques.

17. The computer program product of claim 16, wherein each of the energy source identification signals comprise an encoding of a type and an amount of an energy source used to generate electricity in the electricity stream the energy source identification signal was inducted or reinduced into.

18. The computer program product of claim 17, wherein a type of energy source used to generate electricity can comprise either a renewable energy source, a nuclear energy source, or a fossil energy source.

19. The computer program product of claim 16, wherein the extracting of the one or more energy source identification signals from each of the one or more redistributed electricity streams and the extracting of the energy source identification signal from each of the one or more electricity streams using the one or more demodulation techniques comprises de-embedding encodings of one or more energy sources in each of the one or more redistributed electricity streams and the one or more electricity stream.

20. The computer program product of claim 16, wherein an electricity stream can comprise electricity generated from one energy source, and a redistributed electricity stream can comprise either electricity generated from one energy source, or a mixture of electricity generated from multiple energy sources.
